(19) United States
(12) Patent Application Publication
(10) Pub. No.: US 2017/0311004 A1
(43) Pub. Date: Oct. 26, 2017

(54) VIDEO PROCESSING METHOD AND DEVICE

(71) Applicant: Beijing Xiaomi Mobile Software Co., Ltd., Beijing (CN)

(72) Inventors: Zhigang LI, Beijing (CN); Heng SUN, Beijing (CN); Yang ZHANG, Beijing (CN)

(73) Assignee: Beijing Xiaomi Mobile Software Co., Ltd., Beijing (CN)

(21) Appl. No.: 15/352,308

(22) Filed: Nov. 15, 2016

(30) Foreign Application Priority Data
Apr. 22, 2016 (CN) 201610258583.7

(51) Int. Cl. H04N 21/2187; H04N 21/431; H04N 21/2365; H04N 21/234; H04N 21/414; H04N 21/233; H04W 88/02

(52) U.S. Cl. CPC H04N 21/2187; H04N 21/41407; H04N 21/4312; H04N 21/233; H04N 21/2365; H04N 21/234; H04W 88/02

(57) ABSTRACT

A video processing method includes: receiving multiple channels of video images individually sent from multiple mobile terminals; displaying the multiple channels of video images; acquiring a selection instruction according to a user input, the selection instruction carrying an identifier of a target video image, the target video image including at least one of the multiple channels of video images; and transmitting the target video image to a target terminal. According to embodiments of the disclosure, any desirable video image can be selected from the multiple channels of video images being displayed as the target video image for live broadcasting.

### CROSS-REFERENCE TO RELATED APPLICATION

This application is based on and claims priority to Chinese Patent Application No. 201610258583.7, filed on Apr. 22, 2016, the entire contents of which are incorporated herein by reference.

### TECHNICAL FIELD

The present disclosure relates to the field of communication technology, and more particularly, to a video processing method and a video processing device.

### BACKGROUND

Live video broadcasting is generally implemented by means of internet and streaming media technology. Live video has gradually become a mainstream way of expression on internet due to its integration with abundant elements such as image, text, and sound and excellent effect of audio and video presentation.

Live video broadcasting via mobile phone refers to sharing of on-site events to audiences via a smart phone at any time anywhere through real-time shooting of the smart phone. Until now, however, the live video broadcasting via mobile phone is monotonous in content and, accordingly, causes poor user experience.

### SUMMARY

The present disclosure provides a video processing method and a device thereof

In a first aspect, the present disclosure provides a video processing method. The method includes: receiving multiple channels of video images individually sent from multiple mobile terminals; displaying the multiple channels of video images; acquiring a selection instruction according to a user input, the selection instruction carrying an identifier of a target video image, the target video image including at least one of the multiple channels of video images; and transmitting the target video image to a target terminal.

In a second aspect, the present disclosure provides a video processing device. The video processing device may include: a first receiver configured to receive multiple channels of video images individually sent from multiple mobile terminals; a display configured to display the multiple channels of video images received by the first receiver; an acquiring circuitry configured to acquire a selection instruction according to a user input, the selection instruction carrying an identifier of a target video image, the target video image including at least one of the multiple channels of video images displayed by the display; and a first transmitter configured to transmit the target video image to a target terminal.

In a third aspect, the present disclosure provides a video processing apparatus. The video processing apparatus may include: a processor and a memory configured to store instructions executable by the processor. The video processing apparatus is configured to perform acts including: receiving multiple channels of video images individually sent from multiple mobile terminals; displaying the multiple channels of video images; acquiring a selection instruction according to a user input, the selection instruction carrying an identifier of a target video image, the target video image including at least one of the multiple channels of video images; and transmitting the target video image to a target terminal.

In a fourth aspect, the present disclosure provides a non-transitory computer-readable storage medium having stored therein instructions that, when executed by a processor of a smart terminal device, causes the smart terminal device to perform a video processing method. The method includes: receiving multiple channels of video images individually sent from multiple mobile terminals; displaying the multiple channels of video images; acquiring a selection instruction by a user, the selection instruction carrying an identifier of a target video image, the target video image including at least one of the multiple channels of video images; and transmitting the target video image to a target terminal.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flowchart illustrating a video processing method according to an exemplary embodiment.

FIG. 2 is a schematic diagram illustrating a scenario of a video processing method according to an exemplary embodiment.

FIG. 3 is a flowchart illustrating a video processing method according to another exemplary embodiment.

FIG. 4 is a flowchart illustrating a video processing method according to another exemplary embodiment.

FIG. 5 is a flowchart illustrating a video processing method according to another exemplary embodiment.

FIG. 6A is a flowchart illustrating a process on multiple channels of video images in the target video image according to an exemplary embodiment.

FIG. 6B is a schematic diagram illustrating an interface of a splicing process on multiple channels of video images according to an exemplary embodiment.

FIG. 6C is a schematic diagram illustrating an interface of a superposing process on multiple channels of video images according to an exemplary embodiment.

FIG. 7 is a block diagram illustrating a video processing device according to an exemplary embodiment.

FIG. 8 is a block diagram illustrating a video processing device according to another exemplary embodiment.

FIG. 9 is a block diagram illustrating a video processing device according to another exemplary embodiment.

FIG. 10 is a block diagram illustrating a video processing device according to another exemplary embodiment.

FIG. 11 is a block diagram illustrating an apparatus applicable for processing video according to an exemplary embodiment.

These drawings are not intended to limit a scope of the present disclosure in any way, but to interpret an idea of the present disclosure for those skilled in the related art by referring to particular embodiments.

### DETAILED DESCRIPTION

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

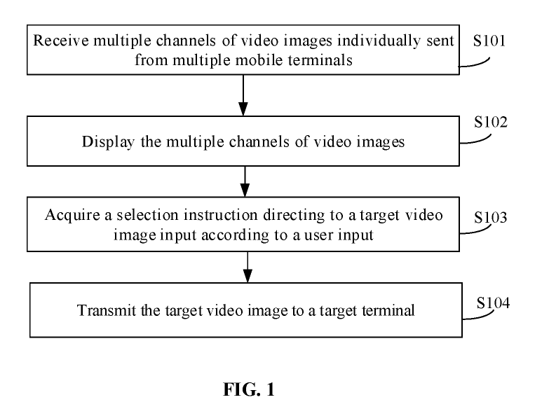

FIG. 1 is a flowchart illustrating a video processing method according to an exemplary embodiment. The video processing method may be implemented in a live broadcasting mobile terminal including such as a mobile phone or a smart terminal, but not limited thereto. As shown in FIG. 1, the video processing method includes following steps S101-S104.

In step S101, multiple channels of video images individually sent from multiple mobile terminals are received.

In an embodiment, one of the multiple mobile terminals serves as the live broadcasting mobile terminal which is able to share and receive the multiple channels of video images from remaining mobile terminals through wireless communication, which may include near field communication (NFC), BlueTooth, WiFi (Wireless Fidelity), or any other wireless communication technology.

Here, the mobile terminal may be a mobile phone, and the multiple channels of video images from mobile terminals may include any one of the following: video image regarding different scenes at the same time, video image regarding different perspectives at the same time, and video image regarding different scenes and different perspectives at the same time. Further, the multiple channels of video images are not limited to the above examples.

In step S102, the multiple channels of video images are displayed.

For example, the live broadcasting mobile terminal may display the multiple channels of video images after receiving the same.

In step S103, a selection instruction directing to a target video image input is acquired. The selection instruction may be obtained according to a user input, which may include: an input on a touch screen of the mobile terminal, a voice input via the mobile terminal,

The selection instruction may carry therein an identifier of the target video image. Herein, the target video image may include at least one of the multiple channels of video images. In other words, a host can select at least one channel of video image for live broadcasting from the multiple channels of video images.

In step S104, the target video image is transmitted to a target terminal.

For example, after receiving the selection instruction according to the user input, the live broadcasting mobile terminal may transmit the target video image to other terminals so as to enable live video broadcasting.

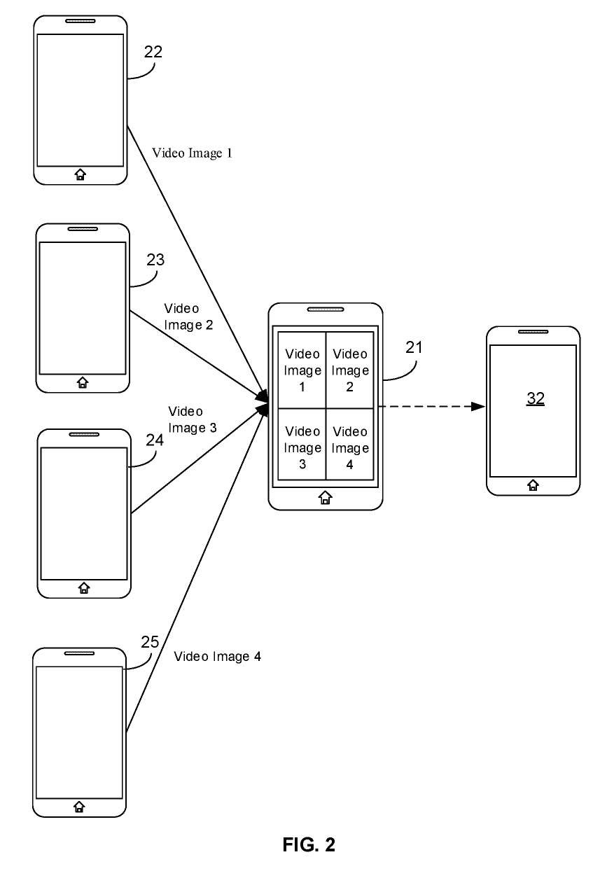

Illustrative description of the disclosure will be now given with reference to FIG. 2. As shown in FIG. 2, a live broadcasting mobile phone 21 receives four channels of video images from mobile phones 22, 23, 24, and 25 and displays the four channels of video images. Assuming that a host desires to broadcast the video image from the mobile phone 22, when an identifier of the video image from the mobile phone 22 is acquired, the live broadcasting mobile phone 21 can transmit the video image from the mobile phone 22 to a target terminal 32 via a server, so as to enable live video broadcasting. According to the embodiment, as can be seen from above, abundant video content is obtained by receiving the multiple channels of video images from the multiple mobile terminals, and any desirable video image can be selected therefrom for live broadcasting, thus user experience can be improved significantly.

According to the embodiment of the video processing method described above, the multiple channels of video images sent from the multiple mobile terminals are displayed, and the target video image is transmitted to the target terminal 32 when a selection instruction directing at the target video image input by the user is acquired, such that any desirable video image can be selected from the multiple channels of video images as the target video image for live broadcasting. Thus, abundant video content is achieved and user experience can be improved significantly.

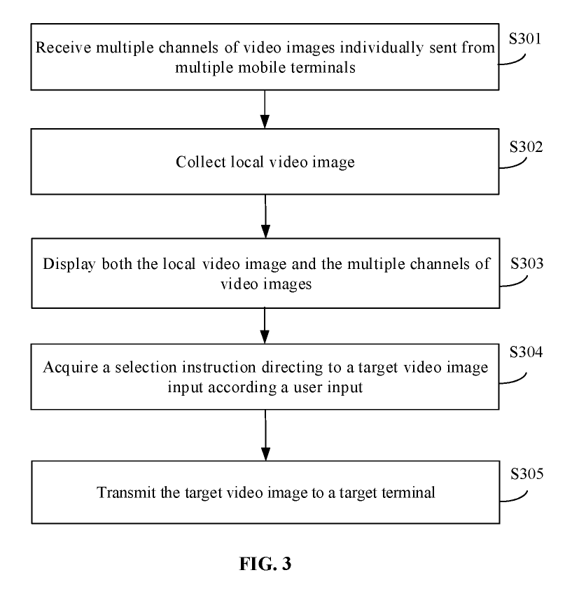

FIG. 3 is a flowchart illustrating a video processing method according to another exemplary embodiment. As shown in FIG. 3, the method includes following steps.

In step S301, multiple channels of video images individually sent from multiple mobile terminals are received.

In step S302, local video image is collected.

In one or more embodiments, when the live broadcasting mobile terminal receives the multiple channels of video images individually sent from multiple mobile terminals, the live broadcasting mobile terminal may collect the local video image using its own cameras in the live broadcasting mobile terminal.

In step S303, the local video image and the multiple channels of video images are displayed.

In step S304, a selection instruction directing to a target video image input by a user is acquired.

Here, the selection instruction may be a voice control instruction. Moreover, the selection instruction may carry therein an identifier of the target video image. The target video image may include at least one of the multiple channels of video images. In other words, a host can select at least one channel of video image for live broadcasting from the multiple channels of video images.

In step S305, the target video image is transmitted to a target terminal.

When the target video image includes two or more of the multiple channels of video images, a superposing or splicing process may be performed on the two or more of the multiple channels of video images in the target video image, and such processed video image is transmitted to other terminals.

According to the embodiment of the video processing method described above, as the multiple channels of video images respectively sent from the multiple mobile terminals are received, the local video image is also collected, and both the local video image and the multiple channels of video images are displayed, such that any desirable video image can be selected, from the local video image and the multiple channels of video images, as the target video image for live broadcasting. Thus, live broadcasting video content is obtained abundantly and user experience can be improved.

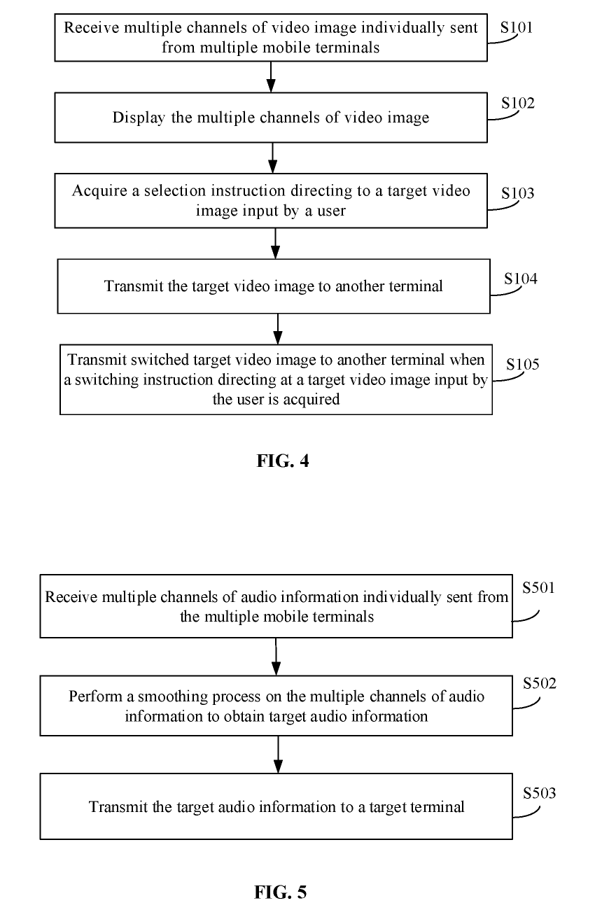

FIG. 4 is a flowchart illustrating a video processing method according to another exemplary embodiment. As shown in FIG. 4, the method includes following steps after step S104.

In step S105, when a switching instruction directing at a target video image input by the user is acquired, switched target video image is transmitted to a target terminal.

Herein, the switching instruction may be a voice control instruction. The voice control instruction may be obtained using at least one microphone embedded in the live broadcasting mobile terminal or any other mobile terminals.

Taking the four channels of video images shown in FIG. 2 for an example, assuming that the video image for current live broadcasting is video image 1, the user desires to broadcast video image 3. When a voice switching instruction indicative of “switching to video image 3” is issued by the host, it can be acquired by the live broadcasting mobile phone 21 which can switch to transmit the video image 3 to other terminals for live broadcasting.

According to the embodiment of the video processing method described above, when the switching instruction directing at a target video image input by the user is acquired, switched target video image is transmitted to other terminals, such that the target video image can be switched and, thus, user experience can be improved significantly.

FIG. 5 is a flowchart illustrating a video processing method according to another exemplary embodiment. As shown in FIG. 5, the method includes following steps based on the embodiment shown in FIG. 4.

In step S501, multiple channels of audio information individually sent from the multiple mobile terminals are received.

In one or more embodiments, the multiple channels of audio information individually sent from the multiple mobile terminals are received in addition to the multiple channels of video images individually sent from the multiple mobile terminals.

In step S502, a smoothing process is performed on the multiple channels of audio information to obtain target audio information.

For example, the smoothing process is performed on the multiple channels of audio information to eliminate noise therein, such that clarity of target audio information can be improved.

In step S503, the target audio information is transmitted to a target terminal.

According to the embodiment described above, the target audio information is obtained clearly by smoothing the multiple channels of audio information and, then, transmitted to other terminals, such that user experience of live video broadcasting can be improved.

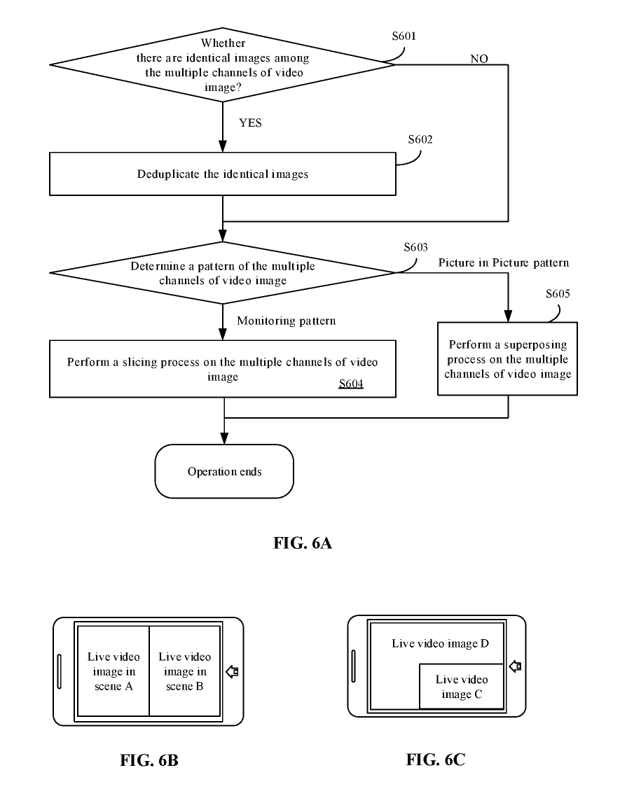

FIG. 6A is a flowchart illustrating a process on multiple channels of video images in the target video image according to an exemplary embodiment. As shown in FIG. 6A, the process includes following steps.

In step S601, it is detected whether there are identical images among the multiple channels of video images, if yes, step S602 is executed and, if no, step S603 is executed.

In an embodiment, there may be identical images between two channels of video images when perspectives of two mobile phones for collecting the video image are identical to each other.

In step S602, one of the identical images is removed.

In step S603, a pattern of the multiple channels of video images is determined. When the multiple channels of video images are in a monitoring pattern, step S604 is executed. When the multiple channels of video images are in a PIP (Picture in Picture) pattern, step S605 is executed.

In an embodiment, the pattern of the multiple channels of video images can be determined based on an event type corresponding to the video image, which may be identified by processing content of the multiple channels of video images through machine learning algorithm or neural network algorithm.

For example, a current event may be identified as a competition event or a celebration event based on the content of the multiple channels of video images. If a competition event is identified, the live broadcasting mobile terminal may display the multiple channels of video images can in the PIP pattern. If a celebration event is identified, the live broadcasting mobile terminal may display the multiple channels of video images in the monitoring pattern.

Accordingly, a simple way of implementation and high accuracy can be achieved by determining the pattern of the multiple channels of video images based on the event type.

In step S604, a splicing process is performed on the multiple channels of video images and, then, operation ends. For example, the live broadcasting mobile terminal may perform splicing process on the two or more of the multiple channels of video images to obtain the target video image and then transmit the obtained target video image to the target terminal.

In an embodiment, the splicing process may be performed on the multiple channels of video images when it is determined the multiple channels of video images are in the monitoring pattern.

For example, when a celebration event is identified by the live broadcasting mobile terminal, the multiple channels of video images generated in different scenes at the same time are spliced into one image. As shown in FIG. 6B, two channels of video images generated in scene A and scene B are spliced into one image, such that live broadcasting of the celebration event can be enabled. Note that FIG. 6B is for illustration, other image splicing methods may be used to merge video images. The image splicing methods may adopt cut-and-paste of image regions from one image onto the same or another image with or without post-processing.

In step S605, a superposing process is performed on the multiple channels of video images and, then, operation ends.

In an embodiment, the superposing process may be performed on the multiple channels of video images when it is determined the multiple channels of video images are in the PIP pattern.

For example, when there is a competition event, one channel of video image may be superposed onto another channel to obtain the PIP channel. As shown in FIG. 6C, video image C is superposed onto video image D, such that live broadcasting of the competition event can be enabled.

According to the embodiment of the video processing method described above, either the splicing process or the superposing process is performed on the multiple channels of video images depending on the pattern of the multiple channels of video images. Thus, the live broadcasting can be implemented in a flexible way with high pertinence and great effect.

There are also provided embodiments of video processing device by the disclosure corresponding to the embodiments of video processing method described above.

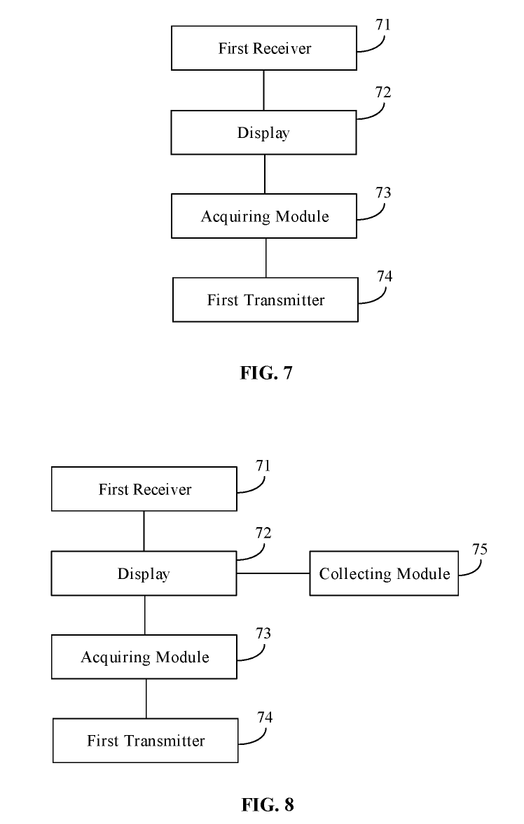

FIG. 7 is a block diagram illustrating a video processing device according to an exemplary embodiment. As shown in FIG. 7, the video processing device includes a first receiver 71, a display 72, an acquiring module 73, and a first transmitter 74.

The first receiver 71 is configured to receive multiple channels of video images individually sent from multiple mobile terminals.

In an embodiment, one of the multiple mobile terminals serves as the live broadcasting mobile terminal which is able to share and receive the multiple channels of video images from remaining mobile terminals through NFC (Near Field Communication) technology such as WiFi (Wireless Fidelity).

Herein, the multiple channels of video images from mobile terminals may include any of video image regarding different scenes at the same time, video image regarding different perspectives at the same time, and video image regarding different scenes and different perspectives at the same time, but are not limited thereto.

The display 72 is configured to display the multiple channels of video images received by the first receiver 71.

The acquiring module 73 is configured to acquire a selection instruction directing to a target video image input by a user, the selection instruction carrying therein an identifier of the target video image which includes at least one of the multiple channels of video images displayed by the display 72.

The first transmitter 74 is configured to transmit the target video image to a target terminal.

In the embodiment, after the selection instruction is obtained according to a user input, the target video image may be transmitted by the first transmitter 74 to other terminals so as to enable live video broadcasting.

In an embodiment, when the target video image includes several channels of video images, the first transmitter 74 is configured to perform superposing or splicing process on the two or more of the multiple channels of video images in the target video image and, then, transmit obtained video image to the target terminal.

As the device shown in FIG. 7 is used to implement steps of the method shown in FIG. 1, involved description may be the same with each other, thus no detailed illustration will be made herein.

According to the embodiment of the video processing device described above, the multiple channels of video images sent from the multiple mobile terminals are displayed, and the target video image is transmitted to a target terminal when a selection instruction directing at the target video image input by the user is acquired, such that any desirable video image can be selected from the multiple channels of video images as the target video image for live broadcasting. Thus, abundant video content is achieved and user experience can be improved significantly.

FIG. 8 is a block diagram illustrating a video processing device according to another exemplary embodiment. As shown in FIG. 8, the device further includes a collecting module 75 based on the embodiment shown in FIG. 7.

The collecting module 75 is configured to collect local video image before displaying the multiple channels of video images at the display 72.

Here, as the multiple channels of video images individually sent from multiple mobile terminals are received, a local video image can be also collected by the video processing device.

Herein, the display 72 may be configured to display the local video image and the multiple channels of video images.

As the device shown in FIG. 8 is used to implement steps of the method shown in FIG. 3, involved description may be the same with each other, thus no detailed illustration will be made herein.

According to the embodiment of the video processing device described above, as the multiple channels of video images respectively sent from the multiple mobile terminals are received, the local video image is also collected, and both the local video image and the multiple channels of video images are displayed, such that any desirable video image can be selected, from the local video image and the multiple channels of video images, as the target video image for live broadcasting. Thus, live broadcasting video content is obtained abundantly and user experience can be improved.

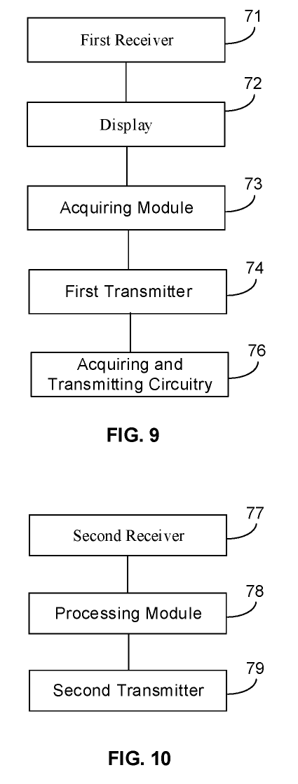

FIG. 9 is a block diagram illustrating a video processing device according to another exemplary embodiment. As shown in FIG. 9, the device further includes an acquiring and transmitting circuitry 76 based on the embodiment shown in FIG. 7.

The acquiring and transmitting circuitry 76 is configured to acquire a switching instruction and transmit switched target video image to a target terminal.

Herein, the switching instruction may be a voice control instruction obtained according to voice input by a user.

Taking the four channels of video images shown in FIG. 2 for an example, assuming that the video image for current live broadcasting is video image 1, the user desires to broadcast video image 3. When a voice switching instruction indicative of “switching to video image 3” is issued by the host, it can be acquired by the live broadcasting mobile phone 21 which can switch to transmit the video image 3 to other terminals for live broadcasting.

As the device shown in FIG. 9 is used to implement steps of the method shown in FIG. 4, involved description may be the same with each other, thus no detailed illustration will be made herein.

According to the embodiment of the video processing device described above, when the switching instruction directing at a target video image input by the user is acquired, switched target video image is transmitted to other terminals, such that the target video image can be switched and, thus, user experience can be improved significantly.

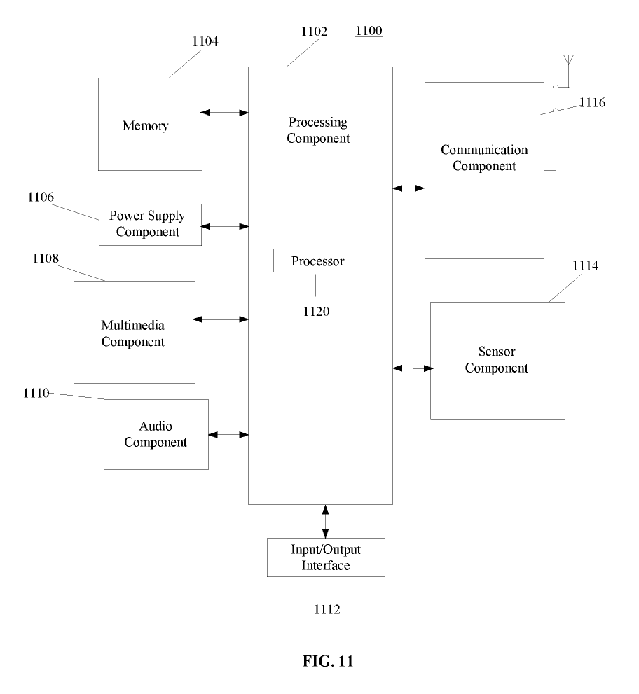

FIG. 10 is a block diagram illustrating a video processing device according to another exemplary embodiment. As shown in FIG. 10, the device further includes a second receiver 77, a processing module 78 and a second transmitter 79 based on the embodiment shown in FIG. 9.

The second receiver 77 is configured to receive multiple channels of audio information individually sent from the multiple mobile terminals.

In an embodiment, the multiple channels of audio information individually sent from the multiple mobile terminals are received in addition to the multiple channels of video images individually sent from the multiple mobile terminals.

The processing module 78 is configured to perform a smoothing process on the multiple channels of audio information received by the second receiver 77 to obtain target audio information.

In an embodiment, the smoothing process is performed on the multiple channels of audio information to eliminate noise therein, such that clarity of target audio information can be improved.

The second transmitter 79 is configured to transmit the target audio information obtained by the processing module 78 to a target terminal.

As the device shown in FIG. 10 is used to implement steps of the method shown in FIG. 5, involved description may be the same with each other, thus no detailed illustration will be made herein.

According to the embodiment described above, the target audio information is obtained clearly by smoothing the multiple channels of audio information and, then, transmitted to other terminals, such that user experience of live video broadcasting can be improved.

With regard to the devices in the foregoing embodiments, detailed description of specific modes for conducting operation of modules has been made in the embodiments related to the method and, thus, no detailed illustration will be made herein.

FIG. 11 is a block diagram illustrating an apparatus applicable for processing video according to an exemplary embodiment. For example, the apparatus 1100 may be a mobile telephone, a computer, a digital broadcasting terminal, a message transceiver, a game control center, a tablet device, a medical device, a fitness device, a personal digital assistant and so on.

Referring to FIG. 11, the apparatus 1100 may include one or more components as below: a processing component 1102, a memory 1104, a power supply component 1106, a multimedia component 1108, an audio component 1110, an input/output (I/O) interface 1112, a sensor component 1114 and a communication component 1116.

The processing component 1102 usually controls the overall operation of the apparatus 1100 such as operations relating to display, making call, data communication, taking photos and recording. The processing component 1102 may include one or more processors 1120 to execute instructions to finish all or part steps of the above method. Besides, the processing component 1102 may include one or more modules for facilitating the interaction between the processing component 1102 and other components. For example, the processing component 1102 may include a multimedia module to facilitate the interaction between the multimedia component 1108 and the processing component 1102.

The memory 1104 is configured to store various types of data to support the operation at the apparatus 1100. Examples of the data include any instructions for performing applications or methods at the apparatus 1100, contact data, phone book data, a message, a picture and a video and so on. The memory 1104 may be any types of volatile or non-volatile storage devices or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or compact disk.

The power supply component 1106 provides power for components of the apparatus 1100. The power supply component 1106 may include a power management system, one or more power supplies, and other related components for generating, managing and distributing power for the apparatus 1100.

The multimedia component 1108 includes a screen which provides an output interface between the apparatus 1100 and the user. In some embodiments, the screen may include a liquid crystal display (LCD) and a touch panel (TP). If the screen includes a touch panel, the screen may be realized to be a touch screen to receive an input signal from the user. The touch panel includes one or more touch sensors to sense touch, slide and gestures on the touch panel. The touch sensor may not only sense the touch or slide boundary, but also detect the duration time and pressure of the touch or slide operation. In some embodiments, the multimedia component 1108 includes a front-facing camera and/or a rear-facing camera. When the apparatus 1100 is in an operation mode, such as a photo mode or video mode, the front-facing camera and/or the rear-facing camera may receive external multimedia data. Each front-facing camera and rear-facing camera may be a fixed optical lens system or have the focal length and optical zoom ability.

The audio component 1110 is configured to output and/or input an audio signal. For example, the audio component 1110 includes a microphone (MIC); when the apparatus 1100 is in an operation mode such as a call mode, a record mode and a speech recognition mode, the microphone is configured to receive an external audio signal. The received audio signal may be further stored in the memory 1104 or sent out by the communication component 1116. In some embodiments, the audio component 1110 may further include a loudspeaker for outputting the audio signal.

The I/O interface 1112 may provide interface between the processing component 1102 and a peripheral interface module. The peripheral interface module may be a keyboard, a click wheel, a button and so on. These buttons include but are not limited to: a homepage button, a volume button, a start button and a lock button.

The sensor component 1114 includes one or more sensors for evaluating states of different aspects of the apparatus 1100. For example, the sensor component 1114 may detect the on/off state of the apparatus 1100, relative locations of components, for example, the components are the displayer and keypads of the apparatus 1100. The sensor component 1114 may further sense the position change of a component of the apparatus 1100 or the position change of the apparatus 1100, whether the touch exists between the user and the apparatus 1100, the direction or acceleration/deceleration of the apparatus 1100, and temperature change of the apparatus 1100. The sensor component 1114 may include a proximity sensor which is configured to sense the existence of a nearby object when no physical contact exists. The sensor component 1114 may further include a light sensor such as a complementary metal-oxide-semiconductor (CMOS) or charge-coupled device (CCD) image sensor, for using in imaging applications. In some embodiments, the sensor component 1114 may further include an acceleration sensor, a gyro sensor, a magnetic sensor, a pressure sensor, or a temperature sensor.

The communication component 1116 is configured to facilitate communicating between the apparatus 1100 and other devices in wired or wireless manner. The apparatus 1100 may be connected to wireless network based on communication standard such as wireless fidelity (Wi-Fi), 2G or 3G or their combinations. In an exemplary embodiment, the communication component 1116 receives, by means of a broadcast channel, a broadcast signal or broadcast-related information from an external broadcast management system. In an exemplary embodiment, the communication component 1116 further includes a near field communication (NFC) module to promote short-range communication. For example, the NFC module may be achieved based on radio frequency identification (RFID) technology, infrared data association (IrDA) technology, ultra-wide bandwidth (UWB) technology, Bluetooth (BT) technology and other technologies.

In exemplary embodiments, the apparatus 1100 may be achieved by one or more circuitries, which include application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components. The apparatus may use the circuitries in combination with the other hardware or software components for executing the method above. Each module, sub-module, unit, or sub-unit disclosed above may be implemented at least partially using the one or more circuitries.

In exemplary embodiments, a non-transitory computer-readable storage medium including an instruction is also provided, for example, the memory 1104 including the instruction. The instruction may be executed by the processor 1120 of the apparatus 1100 to achieve the above method. For example, the non-transitory computer-readable storage medium may be a ROM, a random access memory (RAM), a CD-ROM, a magnetic tape, a floppy disk and optical data storage device, etc.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A video processing method, comprising:
receiving multiple channels of video images individually sent from multiple mobile terminals;
displaying the multiple channels of video images;
acquiring a selection instruction according to a user input, the selection instruction carrying an identifier of a target video image, the target video image comprising at least one of the multiple channels of video images; and
transmitting the target video image to a target terminal.

2. The video processing method as claimed in claim 1, wherein, prior to the displaying the multiple channels of video images, the method further comprises:
collecting local video image; and
wherein displaying the multiple channels of video images comprises:
displaying the local video image and the multiple channels of video images.

3. The video processing method as claimed in claim 1, wherein, when the target video image comprises two or more of the multiple channels of video images, transmitting the target video image to the target terminal comprises:
superposing the two or more of the multiple channels of video images to obtain the target video image and transmitting the target video image to the target terminal.

4. The video processing method as claimed in claim 1, wherein, when the target video image comprises two or more of the multiple channels of video images, transmitting the target video image to the target terminal comprises:
performing splicing process on the two or more of the multiple channels of video images to obtain the target video image and transmitting the obtained target video image to the target terminal.

5. The video processing method as claimed in claim 1, further comprising:
acquiring a switching instruction; and
transmitting switched target video image to the target terminal according to the switching instruction.

6. The video processing method as claimed in claim 5, wherein at least one of the selection instruction and the switching instruction comprises a voice control instruction.

7. The video processing method as claimed in claim 5, further comprising:
receiving multiple channels of audio information individually sent from the multiple mobile terminals;
smoothing the multiple channels of audio information to obtain target audio information; and
transmitting the target audio information to the target terminal.

8. A video processing device, comprising:
a processor; and
a memory configured to store instructions executable by the processor;
wherein the video processing device is configured to perform:
receiving multiple channels of video images individually sent from multiple mobile terminals;
displaying the multiple channels of video images;
acquiring a selection instruction according to a user input, the selection instruction carrying an identifier of a target video image, the target video image comprising at least one of the multiple channels of video images; and
transmitting the target video image to a target terminal.

9. The video processing device as claimed in claim 8, wherein, prior to the displaying the multiple channels of video images, the processor is configured to perform:
collecting local video image; and
wherein displaying the multiple channels of video images comprises:
displaying the local video image and the multiple channels of video images.

10. The video processing device as claimed in claim 8, wherein, when the target video image comprises two or more of the multiple channels of video images, the video processing device is configured to perform transmitting the target video image to the target terminal by:
superposing the two or more of the multiple channels of video images to obtain the target video image and transmitting obtained video image to the target terminal.

11. The video processing device as claimed in claim 8, wherein when the target video image comprises two or more of the multiple channels of video images, the video processing device is configured to perform the transmitting the target video image to the target terminal by:
performing splicing process on the two or more of the multiple channels of video images to obtain the target video image and transmitting obtained target video image to the target terminal.

12. The video processing device as claimed in claim 8, further configured to perform:
acquiring a switching instruction; and
transmitting switched target video image to the target terminal according to the switching instruction.

13. The video processing device as claimed in claim 12, wherein at least one of the selection instruction and the switching instruction comprises a voice control instruction.

14. The video processing device as claimed in claim 12, further configured to perform:
receiving multiple channels of audio information individually sent from the multiple mobile terminals;
smoothing the multiple channels of audio information to obtain target audio information; and
transmitting the target audio information to the target terminal.

15. A non-transitory computer-readable storage medium having stored therein instructions that, when executed by a processor of a smart terminal device, causes the smart terminal device to perform acts comprising:
receiving multiple channels of video images individually sent from multiple mobile terminals;
displaying the multiple channels of video images;
acquiring a selection instruction according to a user input, the selection instruction carrying an identifier of a target video image, the target video image comprising at least one of the multiple channels of video images; and
transmitting the target video image to a target terminal.
